(19) United States
(12) Patent Application Publication
(10) Pub. No.: US 2026/0128204 A1
(43) Pub. Date: May 7, 2026

(54) SOLENOIDAL INDUCTORS WITH DISTRIBUTED GAPS

(71) Applicant: VIRGINIA TECH INTELLECTUAL PROPERTIES, INC., Blacksburg, VA (US)

(72) Inventors: Rajaie Nassar, Blacksburg, VA (US); Qingrui Yuchi, Blacksburg, VA (US); Khai Ngo, Blacksburg, VA (US); Guo-Quan Lu, Blacksburg, VA (US); Mark Cairnie, Orwigsburg, PA (US)

(21) Appl. No.: 19/380,190

(22) Filed: Nov. 5, 2025

Related U.S. Application Data
(60) Provisional application No. 63/716,355, filed on Nov. 5, 2024.

(51) Int. Cl. H01F 27/24; H01F 27/28

(52) U.S. Cl. CPC H01F 27/24; H01F 27/28

(57) ABSTRACT

An example solenoidal inductor includes a core including an inner circumference and an outer circumference, a first end cap and a second end cap, a plurality of spacer layers between the first end cap and the second end cap, and a plurality of intermediate layers including a plurality of outer intermediate layers and a plurality of inner intermediate layers. The plurality of intermediate layers are positioned between the plurality of spacer layers. The solenoidal inductor further includes a solenoidal winding wound around the plurality of inner intermediate layers with a plurality of turns, where each turn is axially shifted with respect to an axis of symmetry.

### CROSS-REFERENCE TO RELATED APPLICATIONS

This application claims the benefit of and priority to U.S. Provisional Patent Application No. 63/716,355, filed Nov. 5, 2024, entitled “SOLENOIDAL INDUCTORS WITH DISTRIBUTED GAPS,” the entire contents of which is hereby incorporated herein by reference. This application is also related to U.S. Non-Provisional patent application Ser. No. 19/309,177 entitled “CABLE-INTEGRATED COAXIAL POWER CONVERTER,” the entire contents of which is hereby incorporated herein by reference.

### STATEMENT REGARDING FEDERALLY SPONSORED RESEARCH OR DEVELOPMENT

This invention was made with government support under grant number DE-AR0001568, awarded by ARPA-E. The government has certain rights in the invention.

### BACKGROUND

Many electronic devices and systems rely upon power at a well-regulated, constant, and well-defined voltage for proper operation. In that context, power conversion devices and systems are relied upon to convert electric power or energy from one form to another. A power converter is an electrical or electro-mechanical device or system for converting electric power or energy from one form to another. As examples, power converters can convert alternating current (AC) power into direct current (DC) power, convert DC power to AC power, provide a DC to DC conversion, provide an AC to AC conversion, change or vary the characteristics (e.g., the voltage rating, current rating, frequency, etc.) of power, or offer other forms of power conversion. A power converter can be as simple as a transformer, but many power converters have more complicated designs and are tailored for a variety of applications and operating specifications.

Inductors play an important role in power electronics, including medium-voltage (MV) power converters, by storing and releasing energy in the form of magnetic fields. Inductors are commonly used for filtering, energy storage, controlling energy flow, and managing ripple in the power conversion process. Solenoidal inductors generally include a coil of wire wound around a core in a cylindrical shape. Solenoidal inductors may experience significant mechanical and thermal stresses when used in MV power converters.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 depicts a side view of an example implementation of a coaxial power converter cell according to various embodiments of the present disclosure.

FIG. 2 depicts an example solenoidal inductor and a sectional schematic of the solenoidal inductor at the indicated section lines, according to various embodiments of the present disclosure.

FIG. 3 depicts the solenoidal inductor shown in FIG. 2 with a portion of a plurality of outer intermediate layers removed and a schematic showing an axial shift of a solenoidal winding of the solenoidal inductor according to various embodiments of the present disclosure.

FIG. 4 depicts a cross-section of the solenoidal inductor shown in FIG. 2 including winding terminations according to various embodiments of the present disclosure.

FIG. 5 depicts another cross-section schematic of the solenoidal inductor shown in FIG. 2 with optimal turns spacing according to various embodiments of the present disclosure.

FIG. 6A depicts a perspective view of a nested solenoidal inductor according to various embodiments of the present disclosure.

FIG. 6B depicts a cross-section of the nested solenoidal inductor shown in FIG. 6A, according to various embodiments of the present disclosure.

FIG. 7 depicts a perspective view of a solenoidal inductor with a plurality of circumferential gaps diametrically aligned with each other according to various embodiments of the present disclosure.

FIG. 8 depicts an inner view of the solenoidal inductor shown in FIG. 7 with a portion of outer intermediate layers of a core removed according to various embodiments of the present disclosure.

FIG. 9 depicts a partial inner view of the solenoidal inductor shown in FIG. 7 with portions of various layers of the core removed according to various embodiments of the present disclosure.

FIG. 10 depicts another partial inner view of the solenoidal inductor shown in FIG. 7 according to various embodiments of the present disclosure

### DETAILED DESCRIPTION

Many electronic devices and systems rely upon power at a well-regulated, constant, and well-defined voltage for proper operation. In that context, power conversion devices and systems are relied upon to convert electric power or energy from one form to another. A power converter is an electrical or electro-mechanical device or system for converting electric power or energy from one form to another. As examples, power converters can convert alternating current (AC) power into direct current (DC) power, convert DC power to AC power, provide a DC to DC conversion, provide an AC to AC conversion, change or vary the characteristics (e.g., the voltage rating, current rating, frequency, etc.) of power, or offer other forms of power conversion. A power converter can be as simple as a transformer, but many power converters have more complicated designs and are tailored for a variety of applications and operating specifications.

Power converters used in substations tend to be bulky. The size of the power converters can be attributed to the need for large transformers, heat sinks, cooling systems, and protective enclosures, among others. In high-power applications, the power converters can take up considerable space in a substation and may need external cooling solutions. The size of the power converters is generally dictated by the power they need to handle, the cooling requirements, and the insulation needed to manage high voltages safely. However, these power converters are essential for the functioning of various distributive systems such as energy storage systems, AC load systems, electric vehicle (EV) charging systems, and other types of distributive systems that receive power from substations.

In the future, electrical grids will likely undergo a transformative evolution, driven by electrification, distributed renewables, and the adoption of medium voltage DC (MVDC) technology. Electrification will extend beyond traditional sectors like transportation to encompass heating and industrial processes, increasing demand. Distributed renewables, such as solar panels and wind turbines, will decentralize power generation, reducing reliance on centralized power plants and enhancing resilience. MVDC, with its efficiency advantages over AC, will facilitate long-distance transmission, integration of renewables, and grid stability.

These advancements will enable smarter, more flexible grids capable of balancing fluctuating supply and demand while reducing greenhouse gas emissions. Key initiatives include the integration of smart grid technologies, deployment of advanced metering infrastructure, and implementation of grid automation and control systems. These efforts aim to enhance grid reliability, efficiency, and resilience while accommodating the growing penetration of renewable energy sources and electric vehicles (EVs). Furthermore, the adoption of energy storage solutions and demand response programs enables better management of peak loads and promotes grid flexibility.

Amidst this transformation, power electronics has seen further penetration into the grid, offering numerous advantages, including enhanced grid stability through fast response times and voltage regulation, increased efficiency leading to reduced energy losses, and improved integration of renewable energy sources. Power electronics also support grid stabilization and voltage regulation through the deployment of flexible AC transmission systems (FACTS) devices, such as static var compensators (SVCs) and static synchronous compensators (STATCOMs). While the advantages of power electronics are well understood, scaling and manufacturing these systems at the level required for widespread adoption poses several challenges. Notable challenges include, high complexity, high voltage and current handling, thermal management, material selection and sourcing, testing and quality assurance, and scale-up and cost considerations, among others.

Fueled by these challenges, power electronics engineers are investigating new techniques for manufacturing and integrating power electronics assemblies, in an effort to combine multiple components or functions into a single component, saving space, reducing cost, and improving yield. Popular integration topics include multi-chip modules (MCM), which integrate multiple switch devices onto a single substrate or package, simplifying manufacturing of high current systems by making it easier to parallel large numbers of devices. Building on the MCM principle, intelligent power modules (IPMs) have also gained interest, which integrate the switch devices as well as auxiliary functions like gate drivers, sensing, and protection on a single substrate. The principle has recently been extended to include a complete converter, integrating passive components and transformers onto a common substrate creating a dense, modular power converter.

Inductors play an important role in power electronics, including medium-voltage (MV) power converters, by storing and releasing energy in the form of magnetic fields. Inductors are commonly used for filtering, energy storage, controlling energy flow, and managing ripple in the power conversion process. Solenoidal inductors generally include a coil of wire wound around a core in a cylindrical shape. Solenoidal inductors may experience significant mechanical and thermal stresses when used in MV power converters. Estimating the power loss of inductors can be important in designing magnetic components for power electronic converters to meet efficiency targets and design adequate thermal management systems.

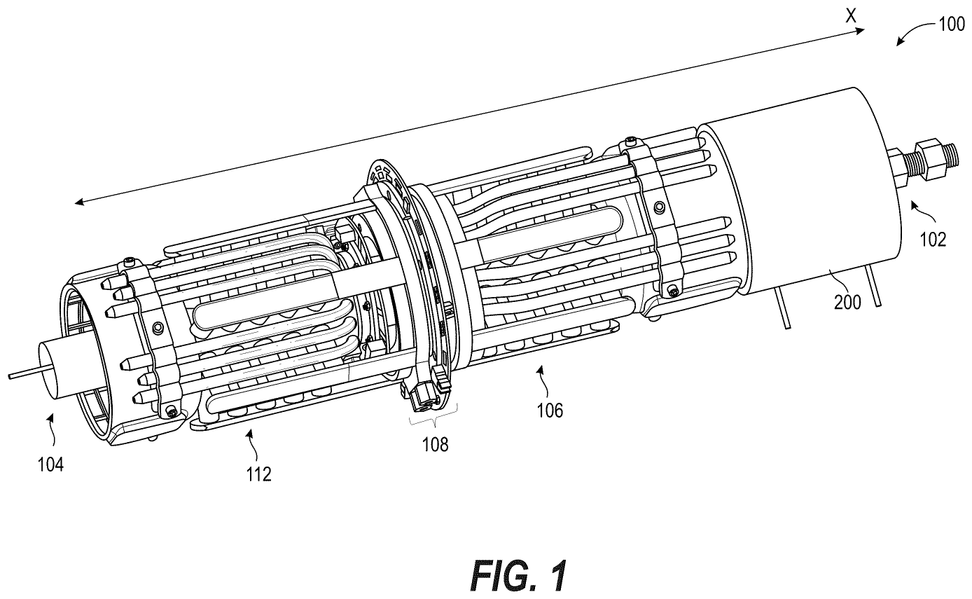

Various embodiments of the present disclosure are directed to solenoidal inductors. These solenoidal inductors can be implemented in coaxial power converter cells, such as the coaxial power converter shown in FIG. 1, which can be used to achieve a high direct current (DC) voltage step down ratio of 10 kV to 400 V and an output power of 250 KW, for example. It should be understood that the coaxial power converter cell shown in FIG. 1 is not limited to any particular step down ratio and can be used to achieve other high DC voltage step down ratios or DC voltage step up ratios in some cases. The solenoidal inductors according to the embodiments can also be used in other types of power converters as well, such as step up power converters.

An example solenoidal inductor according to the embodiments includes a core including an inner circumference and an outer circumference, a first end cap and a second end cap, a plurality of spacer layers between the first end cap and the second end cap, a plurality of intermediate layers including a plurality of outer intermediate layers and a plurality of inner intermediate layers, where the plurality of intermediate layers are positioned between the plurality of spacer layers. The solenoidal inductor further includes a solenoidal winding wound around the plurality of inner intermediate layers with a plurality of turns, where each turn is axially shifted with respect to an axis of symmetry.

Referring now to the drawings, FIG. 1 depicts an example implementation of a coaxial power converter cell 100 according to various embodiments of the present disclosure. The coaxial power converter cell 100 can be one of many cells which can be implemented in a coaxial power converter that can be connected to various types of cables such as MV cables, for converting DC to DC, AC to DC, DC to AC, and AC to AC. The coaxial power converter cell 100 can be used in conjunction with other coaxial cells to either step down or step up an input voltage to an output voltage to be suitable for use across various types of loads. For example, the coaxial power converter can implement a cascaded configuration across multiple cells to gradually step up or step down to the required voltage levels. The coaxial structure of the power converter cell 100 reduces insulation needs, provides passive cooling functionality, and provides seamless integration with the power cables connectable to the coaxial power converter.

The coaxial power converter cell 100 includes a first coaxial capacitor array 112 located proximally to an input end 104, a second coaxial capacitor array 106 located proximally to an output end 102, a coaxial semiconductor package 108 coupled between the first coaxial capacitor array 112 and the second coaxial capacitor array 106, and a solenoidal inductor module 200, which can be coupled to the second coaxial capacitor array 106.

The coaxial power converter cell 100 incorporates a substantially coaxial shape for easy integration and implementation with cables and also to minimize disturbances to the E-field distribution. The coaxial shape is adopted for each of the coaxial capacitor arrays 112 and 106, the coaxial semiconductor package 108, and the solenoidal inductor 200. The coaxial capacitor arrays 112 and 106, the coaxial semiconductor package 108, and the solenoidal inductor 200 are arranged to form the coaxial power converter cell 100 and extend along a longitudinal axis “X.” In one example, the coaxial power converter cell 100 measures approximately 53 cm long with a 13 cm diameter. The coaxial power converter cell 100 can be rated for 50 kW and a maximum input voltage of 5 kV according to one example. Additional details regarding the coaxial power converter cell 100 can be found in U.S. Non-Provisional patent application Ser. No. 19/309,177 entitled “CABLE-INTEGRATED COAXIAL POWER CONVERTER,” the contents of which is hereby incorporated herein by reference in its entirety.

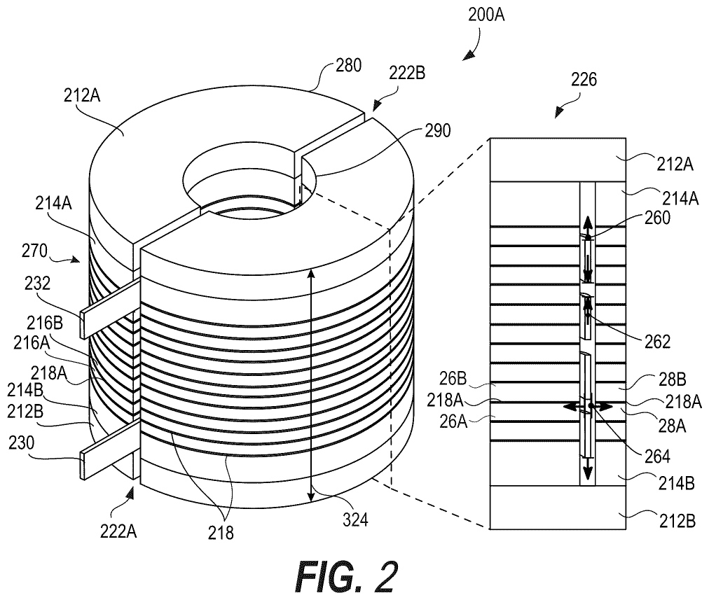

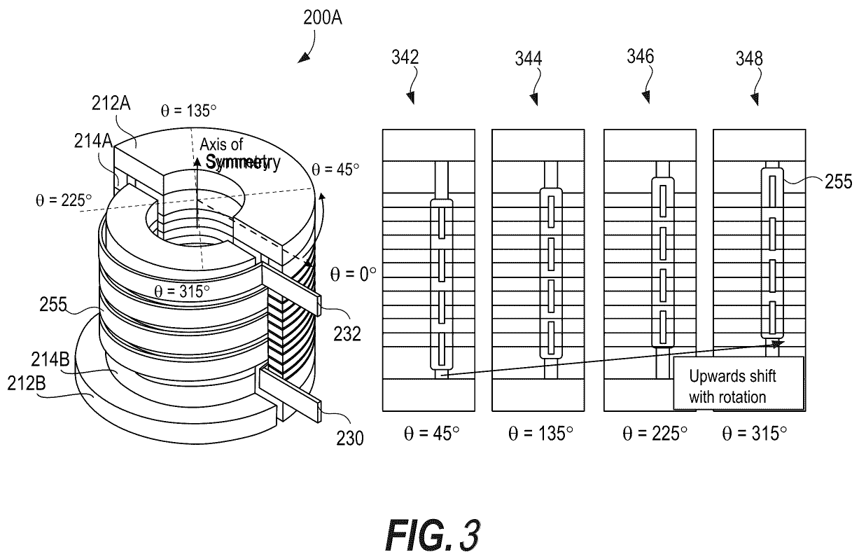

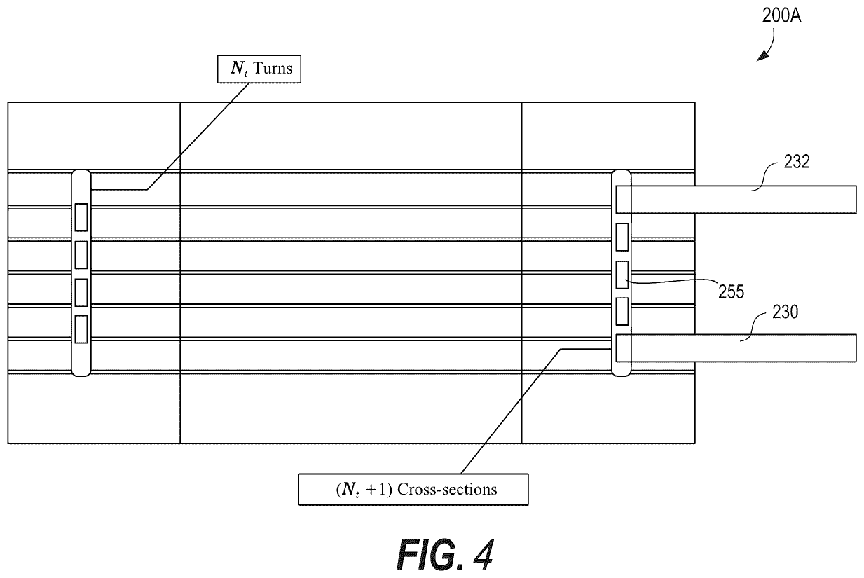

FIG. 2 depicts an example solenoidal inductor 200A and a schematic of the solenoidal inductor 200A at the indicated section lines, FIG. 3 depicts the solenoidal inductor 200A with a portion of a plurality of outer intermediate layers removed and a schematic showing an axial shift of a solenoidal winding of the solenoidal inductor 200A, and FIG. 4 depicts a cross-section of the solenoidal inductor 200A including winding terminations according to various embodiments of the present disclosure. The solenoidal inductor 200A shown in FIGS. 2 and 3 is not exhaustively illustrated, meaning that other components not shown in FIG. 2 can be included or relied upon in some cases. Alternatively, one or more components shown in FIGS. 2 and 3 can be omitted in some cases. The solenoidal inductor 200A can be implemented in the coaxial power converter cell 100 (FIG. 1) as a variant of the solenoidal inductor module 200.

The solenoidal inductor 200A can satisfy the coaxial packaging requirement of the coaxial power converter cell 100, which can necessitate a cylindrical geometry for all components with constrained inner and outer diameters. The solenoidal inductor 200A includes a core 270 including an outer circumference 280, an inner circumference 290, a hollow center within the inner circumference 290, a first end cap 212A, a second end cap 212B, a first spacer layer 214A, a second spacer layer 214B, a plurality of intermediate layers 216 including a plurality of outer intermediate layers 28 (also referred to herein as a plurality of outer rings) positioned between the spacer layers 214A and 214B and a plurality of inner intermediate layers 26 (also referred to herein as a plurality of inner rings and shown in schematic 226) positioned between the spacer layers 214A and 214B. The core 270 includes a plurality of circumferential gaps 222A and 222B which partition the core 270 effectively into two separate sections. The circumferential gaps 222A and 222B are discussed in further detail in the following paragraphs.

The core 270 can be embodied as a ferrite core including manganese-zinc (MnZn) ferrites. MnZn ferrites were chosen over nickel-zinc (NiZn) ferrites because of the lower switching frequency (100 kHz versus several MHz). The properties of the MnZn ferrite can affect the maximum permissible flux density in the core 270 and the optimal number of turns because the MnZn ferrites can handle a higher flux density than the NiZn materials. The core 270 includes a hollow center or hole which can add another degree of freedom and reduces the area available for the magnetic flux. Additionally, copper turns that are thicker than two skin depths can reduce the copper loss of the solenoidal inductor 200A due to the current's significant DC component. Also, the large AC ripple needed to realize soft switching can increase the rms current rating, which can reduce the optimal number of turns (Nₜ) needed to minimize total loss.

In addition, the passive cooling requirement of the coaxial power converter cell 100 poses a watt/meter limitation on the solenoidal inductor 200A, which can cause the solenoidal inductor 200A to require more intermediate ferrite layers to reduce the power per length metric. Thus, long rectangular copper turns can optimally utilize the tall and narrow winding window resulting from the combination of a large amount of intermediate ferrite layers and a low number of winding turns. With these constraints, the solenoidal inductor 200A is designed to meet the intended loss of the coaxial power converter cell 100 to ensure satisfying the efficiency targets and proper thermal operation, especially when no active cooling system is used. Such design takes into consideration for 3-D loss effects or copper loss mechanisms (CLMs), such as axial shift 260, turn-to-turn spacing 262, and radial shift 264 of a solenoidal winding 255 of the solenoidal inductor 200A (FIG. 2).

It should be noted that although the circumferential gaps 222A and 222B partition the core into two separate sections, the end caps 212A and 212B, the plurality of intermediate layers 216, and the spacer layers 214A and 214B include all separated pieces that are partitioned from the circumferential gaps 222A and 222B. Furthermore, the spacer layers 214A and 214B each include outer portions and inner portions. For example, the outer portions of the spacer layers 214A and 214B are shown in FIG. 2, while the inner portions of the spacer layers 214A and 214B are shown in FIG. 3.

The spacer layers 214A and 214B are positioned between the end caps 212A and 212B. The plurality of intermediate layers 216 are positioned between the spacer layers 214A and 214B. In the example shown in FIGS. 2 and 3, there are eleven (11) outer intermediate layers 28, although the solenoidal inductor 200A can implement greater than or fewer than 11 outer intermediate layers 28. The number of the inner intermediate layers 26 matches the number of the outer intermediate layers 28 (e.g., there are 11 inner intermediate layers 26 in the example shown in FIGS. 2 and 3). Additionally, the plurality of inner intermediate layers 26 is aligned with the plurality of outer intermediate layers 28. For example, an inner intermediate layer 26B is aligned with an outer intermediate layer 28B, and an inner intermediate layer 26A is aligned with an outer intermediate layer 28A, as shown in the schematic 226.

Each of the plurality of intermediate layers 216 is the same in thickness. Each of the spacer layer 214A and the spacer layer 214B have the same thickness. The spacer layer 214A and the spacer layer 214B are each thicker than each of the plurality of intermediate layers 216. Each of the end caps 212A and 212B have the same thickness. The end cap 212A or 212B is thicker than each of the plurality of intermediate layers 216 but not as thick as the spacer layer 214A or 214B. In one example, the inner circumference 290 measures 50 mm, the outer circumference 280 measures 120 mm, and a length 324 of the solenoidal inductor 200A measures 107 mm, and other dimensions can be relied upon.

The solenoidal inductor 200A includes a solenoidal winding 255 (FIG. 3) with winding terminations 230 and 232 extending out of the core 270 in the first direction. The solenoidal winding 255 is wound around the plurality of inner intermediate layers 26 and is positioned between the plurality of inner intermediate layers 26 and the plurality of outer intermediate layers 28.

The circumferential gaps 222A and 222B are distributed circumferentially with respect to the outer circumference 280 and the inner circumference 290 and partition the core 270 into two separate pieces as mentioned above. The circumferential gaps 222A and 222b are diametrically aligned with each other. The circumferential gaps 222A and 222B extend through the end caps 212A and 212B, the spacer layers 214A and 214B, and the plurality of intermediate layers 216. Each of the circumferential gaps 222A and 222B extends from the inner circumference 290 to the outer circumference 280. Although two circumferential gaps 222A and 222B are shown in FIGS. 2 and 3, the solenoidal inductor 200A can include more than two circumferential gaps, such as four circumferential gaps or six circumferential gaps.

The circumferential gaps 222A and 222B can mitigate the toroidal effect that can be present in the core 270. For example, current through the solenoidal inductor 200A may mostly flow in the circumferential direction, especially in the plurality of outer intermediate layers 28, but may slowly travel in the axial direction to reach both ends of the solenoidal inductor 200A. Whether the winding terminations 230 and 232 are axially or radially oriented, the rated current can still propagate axially through the structure, passing through the plurality of outer intermediate layers 28 that form an easy magnetic flux path around the solenoidal winding 255. This current can create a one turn toroid in each outer intermediate layer (e.g., outer intermediate layer 28A), with a circumferential flux orthogonal to the desired axial flux. The unintentional flux can cause the plurality of outer intermediate layers 28 to reach a saturation limit, significantly increasing the core loss past expectations.

The circumferential gaps 222A and 222B can increase the reluctance seen by the circumferential flux component without significantly affecting the desired axial flux, facilitating mitigation of core loss in the core 270. According to one example, the core loss in the plurality of outer intermediate layers 28 was decreased from 260 W to 10 W by implementation of the circumferential gaps 222A and 222B, corresponding to a 26-times reduction. The circumferential gaps 222A and 222B extending through the plurality of inner intermediate layers 26 can help to avoid parasitic coupling with conductors (e.g., such as high-voltage busbars and communication cables) running along the axis of the coaxial power converter cell 100 (FIG. 1) through the solenoidal inductor 200A (e.g., through the hollow center of the solenoidal inductor 200A).

The core 270 also includes a plurality of distributed gaps 218 which separates each ferrite layer of the core 270. The plurality of distributed gaps 218 separate each of the plurality of intermediate layers 216, the end cap 212A from the spacer layer 214A, and the end cap 212B from the spacer layer 214B. For example, the distributed gap 218A separates intermediate layer 216A from intermediate layer 216B. Each of the plurality of distributed gaps 218 separates the core 270 further into additional partitions or pieces. Additionally, each distributed gap of the plurality of distributed gaps 218 extends between two diametrically opposed points along the outer circumference 280. Therefore, a single distributed gap can separate two of the outer intermediate layers 28 and two of the inner intermediate layers 26 of the plurality of intermediate layers 216.

In the examples shown in FIGS. 2 and 3, the core 270 includes fourteen (14) distributed gaps. Each of the distributed gaps 218 is an air gap, which is a non-magnetic space intentionally introduced to improve the thermal properties of the solenoidal inductor 200A. Preferably, each of the distributed gaps 218 includes ceramics with very low magnetic permeability such as aluminum nitride (AlN), aluminum oxide (Al₂O₃), or another similar compound.

The core 270 and the solenoidal winding 255 may generate large amounts of heat during operation, and the plurality of distributed gaps 218 can facilitate in dispersing the heat generated by the core 270 and the solenoidal winding 255. For example, the core 270, which can include ferrite, has a very low thermal conductivity k, and each of the plurality of distributed gaps 218 has a higher k (i.e., up to 100 times more thermally conductive than that of the core 270). Thus, the heat generated by the core 270 and the solenoidal winding 255 can be dispersed and cooled via the plurality of distributed gaps 218.

The winding terminations 230 and 232 can be configured to exit the core 270 at either of the circumferential gaps 222A or 222B radially (through the plurality of outer intermediate layers 28) or axially (through the end caps 212A or 212B). Ensuring that no easy magnetic path encloses the exiting location of the winding terminations 230 and 232 is important to avoid additional losses and inductance for the solenoidal inductor 200A. Regardless of the choice of termination style, a solenoidal winding (e.g., the solenoidal winding 255) fabricated from a single piece of copper can result in an extra turn cross section in the winding window at the exiting location of the winding terminations 230 and 232, as seen in FIG. 4. For example, the solenoidal winding 255 in the example shown in FIG. 4 includes Nₜ turns (e.g., four turns) but Nₜ+1 (e.g., five turn) cross sections.

Referring back to FIGS. 2 and 3, the solenoidal winding 255 is spirally wound around the plurality of inner intermediate layers 26 with an axial shift 260 with respect to the axis of symmetry. The axial shift of the turns of the solenoidal winding 255 is a property of the solenoidal copper winding realization. Most hand-wound inductor windings are made from a single piece of copper wire or strip coiled around a bobbin Nr times to form the winding with the required number of turns. Due to the spiral shape of the solenoidal winding 255, the set of turns are axially shifted as they rotate around the axis of symmetry of the solenoidal inductor 200A, as shown in schematics 342, 344, 346, and 348.

Defining the rotation angle θ=0 degrees at the winding terminations 230 and 232, cross sections at multiple angles are taken to track the position of the turns of the solenoidal winding 255 at the winding window. For example, the schematic 342 is taken when θ=45 degrees with respect to the axis of symmetry, the schematic 344 is taken when θ=135 degrees with respect to the axis of symmetry, the schematic 346 is taken when θ=225 degrees with respect to the axis of symmetry, and the schematic 348 is taken when θ=315 degrees with respect to the axis of symmetry. The schematics 342, 344, 346, and 348 depict that the turns of the solenoidal winding 255 shift axially upwards as they rotate around the central axis, resulting in the turns seeing a different fringing field at different values of θ, causing the current distribution within them and the copper loss to change with the rotation angle.

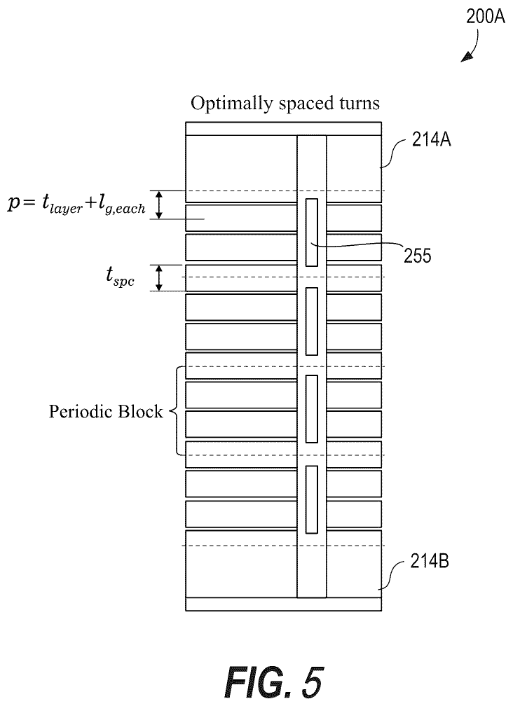

FIG. 5 depicts another cross-section schematic of the solenoidal inductor 200A with optimal turns spacing according to various embodiments of the present disclosure. To achieve optimal turn-to-turn spacing 262 between turns of the solenoidal winding 255, the spacer layers 214A and 214B (FIGS. 2 and 3) are used to achieve low copper loss and a realizable cross-section. By distributing the total gap over a small number of layers, the required optimal spacing of the turns becomes smaller, creating the extra room needed at the exit location of the winding terminations 230 and 232. This design can be implemented as long as the total core and circumferential gap lengths of the solenoidal inductor 200A remain relatively the same because the total reluctance is unchanged (without significantly changing the circumferential gap lengths).

To minimize the copper loss, the optimal turn-to-turn spacing 262 and gaps can achieve periodic symmetry for periodic blocks of the solenoidal inductor 200A. Using simple geometric algebra, the optimal turn spacing t_{spc,opt} of the solenoidal winding 255 can be expressed as follows:

$${t}_{spc , opt} = \frac{{N}_{fe} + {t}_{layer} + {ℓ}_{g , each}}{{N}_{t}} - {ℓ}_{Cu} , \qquad ( 1 )$$

where N_{fe} is the number of intermediate layers (e.g., the intermediate layers 216), t_{layer} is the thickness of each intermediate layer (e.g., the outer intermediate layer 28A), [symbol] is the thickness of each distributed gap (e.g., the distributed gap 218A) between each intermediate layer, [symbol] is the thickness of each turn of the solenoidal winding 255, and Nₜ is the number of turns of the solenoidal winding 255.

Equation (1) assumes that the chosen dimensions satisfy the following:

$${t}_{spc , opt} > 0 \to {N}_{t} {ℓ}_{Cu} < ( {N}_{fe} + 1 ) ( {t}_{layer} + {ℓ}_{g , each} ) . \qquad ( 2 )$$

According to one example, the t_{spc,opt} was calculated using equation (1) for the solenoidal inductor 200A where N_{fe}=11 and t_{layer}=5 mm with four, five, and six rectangular turns, four round wire turns, and four turns of two parallel round windings. The results are summarized in Table 1 below, which compares the calculated values from the ones obtained from 2-D FEA sweeps.

TABLE 1

| | | | | | Two |
|---|---|---|---|---|---|
| | | | | Single | Parallel |
| | | | | Round | Round |
| | Rectangular Wire | | | Wire | Wires |
| Simulated Case | 4 Turns | 5 Turns | 6 Turns | 4 Turns | |
| Turn Length/ | 12 | 9.6 | 8 | Ø3.26 | Ø3.26 |
| Diameter - [symbol] _{Cu} (mm) | | | | | |
| Gap Length - | 0.305 | 0.530 | 0.848 | 0.305 | 0.305 |
| [symbol] _{g, each} (mm) | | | | | |
| Optimal Spacing | 4.00 | 3.90 | 3.80 | 12.70 | 4.70 |
| from 2-D FEA (mm) | | | | | |
| Optimal Spacing | 3.92 | 3.67 | 3.70 | 12.66 | 4.70 |
| from (1) (mm) | | | | | |
| Percentage Error (2-D | −2.0% | −5.9% | −2.6% | −0.3% | 0.0% |
| FEA as reference) | | | | | |

The results from Table 1 show a maximum percentage error of 6% for one case and a good match for others (<3% error). The results further demonstrate that equation (1) reasonably estimates the optimal turn-to-turn spacing with minimal copper loss.

The radial shift 264 of the turns of the solenoidal winding 255 can impact the copper loss of the solenoidal inductor 200A. The core loss of the core 270 does not vary with the radial positioning of the solenoidal winding 255, but the copper loss can increase as the solenoidal winding 255 shifts away from a minimal loss point. The loss increase is almost symmetrical around the 0 mm radial shift point, which represents the radial centering of the turns of the solenoidal winding 255 in the winding window. The copper loss has a flat valley around the minimum and a sharp increase as the turns get too close to the distributed gaps (e.g., of the distributed gaps 218) on either side of the core 270. This can be attributed to the increased fringing effects on the current distribution and can be minimized by staying within the ±10% error band when fabricating the solenoidal inductor 200A.

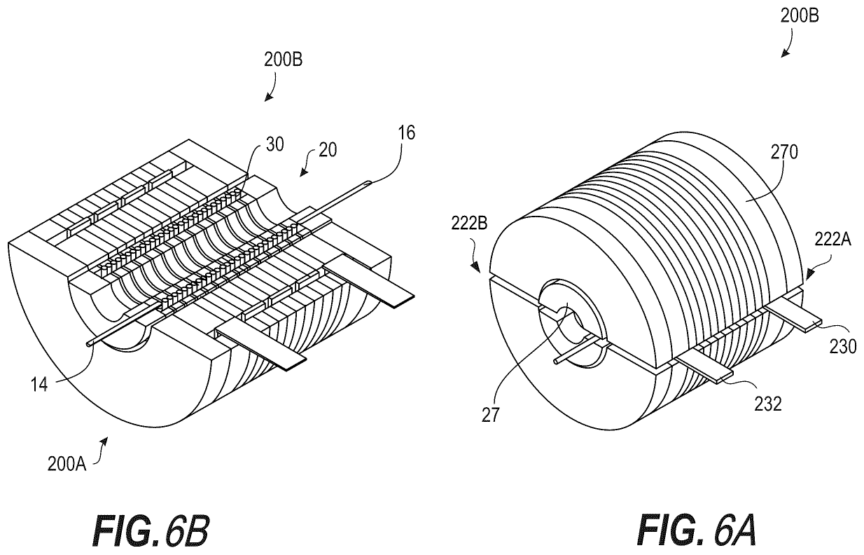

FIG. 6A depicts a perspective view of a nested solenoidal inductor 200B, and FIG. 6B depicts a cross-section of the nested solenoidal inductor 200B according to various embodiments of the present disclosure. The nested solenoidal inductor 200B is a solenoidal inductor including the solenoidal inductor 200A and a second solenoidal inductor 20 coaxially nested within the solenoidal inductor 200A. For example, the second solenoidal inductor 20 is positioned within the hollow center of the core 270 and within the inner circumference 290 of the core 270. The nested solenoidal inductor 200B is a variant of the solenoidal inductor module 200 and can be implemented in the coaxial power converter cell 100. The structures of the second solenoidal inductor 20 and the solenoidal inductor 200A are substantially similar with differences in dimensions. For example, the second solenoidal inductor 20 includes a core 27 with the same number of end caps as the core 270 of the solenoidal inductor 200A, the same number of spacer layers as the core 270 of the solenoidal inductor 200A, and the same number of intermediate layers as the core 270 of the solenoidal inductor 200A.

The thicknesses of the end caps, the spacer layers, and the intermediate layers of the second solenoidal inductor 20 are also proportional to each other in the same manner as that described with respect to the solenoidal inductor 200A. The second solenoidal inductor 20 includes a solenoidal winding 30 which includes a greater number of turns than that of the solenoidal winding 255 of the solenoidal inductor 200A. In particular, the second solenoidal inductor 20 can be used in the coaxial power converter cell 100 as a high voltage input inductor, and the solenoidal inductor 200A can be used in the coaxial power converter cell 100 as a low voltage output inductor. Additionally, the second solenoidal inductor 20 includes winding terminations 14 and 16 which exit outwardly from the core 27 in opposite directions from each other. The directions that the winding terminations 14 and 16 exit from the core 27 are perpendicular to the direction that the winding terminations 230 and 232 exit from the core 270.

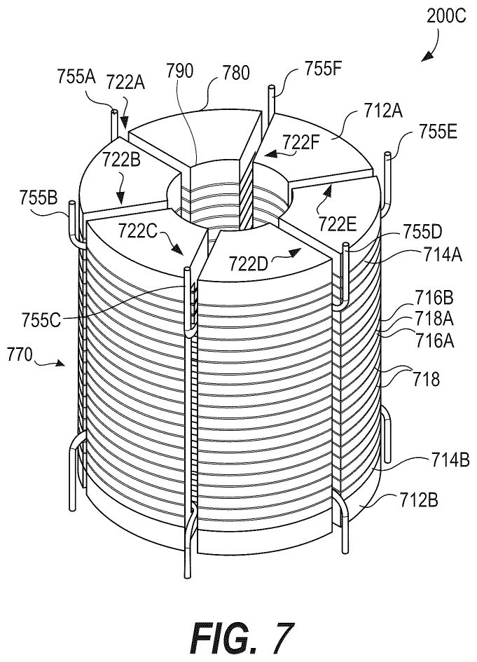

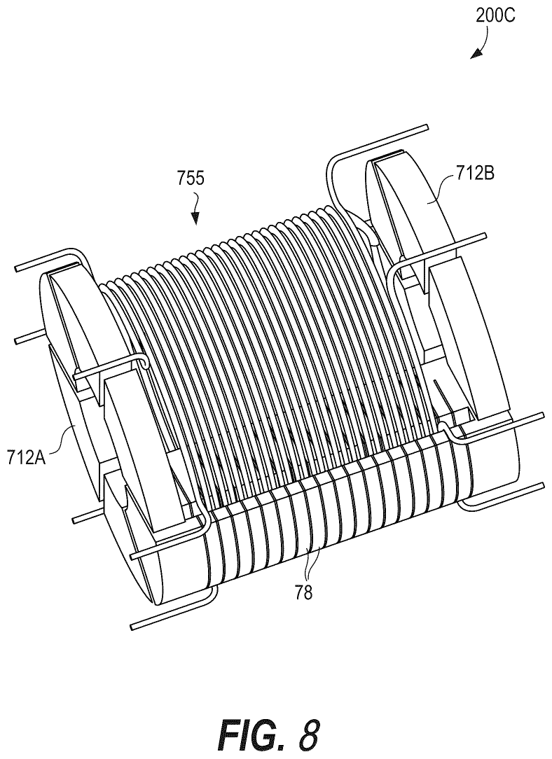

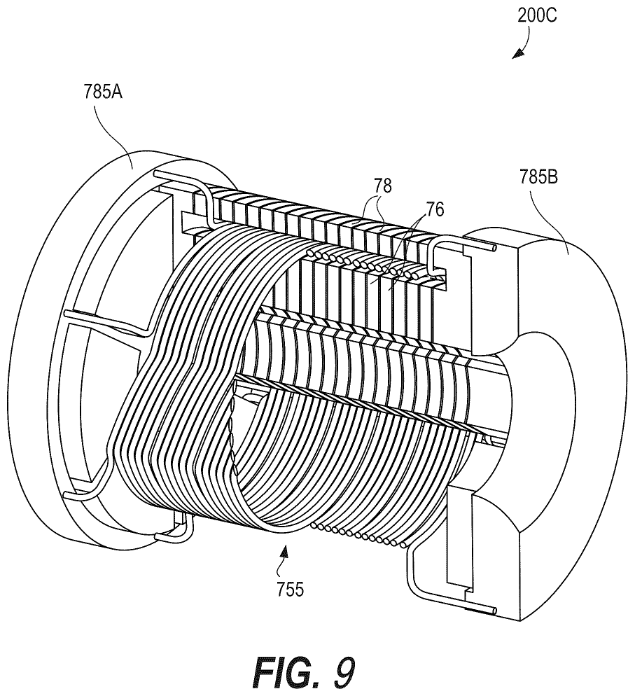

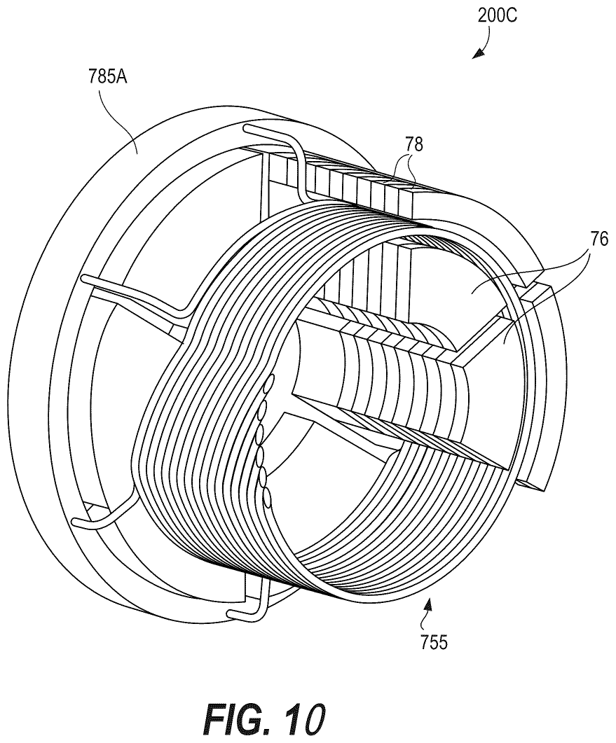

FIG. 7 depicts a perspective view of a solenoidal inductor 200C with a plurality of circumferential gaps diametrically aligned with each other, FIG. 8 depicts an inner view of the solenoidal inductor 200C with a portion of outer intermediate layers of a core removed, FIG. 9 depicts a partial inner view of the solenoidal inductor 200C with portions of various layers of the core removed, and FIG. 10 depicts another partial inner view of the solenoidal inductor 200C according to various embodiments of the present disclosure. The solenoidal inductor 200C is a variant of the solenoidal inductor module 200 and can be implemented in the coaxial power converter cell 100.

Similar to the core 270 of the solenoidal inductor 200A, the core 770 can be embodied as a ferrite core including MnZn ferrites. The core 770 includes a hollow center or hole which can add another degree of freedom and reduces the area available for the magnetic flux. The operating principles of the solenoidal inductor 200C are similar to the operating principles of the solenoidal inductor 200A. Therefore, the structure of the core 770 of the solenoidal inductor 200C is similar to the structure of the core 270 of the solenoidal inductor 200A, albeit with more intermediate layers and partitions due to the presence of more circumferential gaps and more distributed gaps.

The solenoidal inductor 200C is coaxial or cylindrical in shape and includes a core 770 including an outer circumference 780, an inner circumference 790, a hollow center within the inner circumference 790, a first end cap 712A, a second end cap 712B, a first spacer layer 714A, a second spacer layer 714B, a plurality of intermediate layers 716 including a plurality of outer intermediate layers 78 (see FIG. 8 and also referred to herein as a plurality of outer rings) positioned between the spacer layers 714A and 714B and a plurality of inner intermediate layers 76 (see FIG. 9 and also referred to herein as a plurality of inner rings) positioned between the spacer layers 214A and 214B. The core 770 includes a plurality of circumferential gaps 722A, 722B, 722C, 722D, 722E, and 722F (e.g., the plurality of circumferential gaps 722), which partition the core 270 effectively into six separate sections.

In contrast to the solenoidal inductor 200A, the solenoidal inductor 200C includes a plurality of solenoidal windings 755A, 755B, 755C, 755D, 755E, and 755F (e.g., the plurality of solenoidal windings 755). The plurality of solenoidal windings 755 are wound around the plurality of inner intermediate layers 76, as can be seen in FIGS. 9 and 10. The plurality of solenoidal windings 755 are intertwined and nested coaxially with each other and positioned between the plurality of outer intermediate layers 78 and the plurality of inner intermediate layers 76. Each of the plurality of solenoidal windings 755 is circular or cylindrical in shape. Similar to the turns of the solenoidal winding 255 of the solenoidal inductor 200A, turns of the plurality of solenoidal windings 755 of the solenoidal inductor 200C can adopt a similar axial shift and radial shift.

The plurality of circumferential gaps 722 are symmetrically arranged with respect to the outer circumference 780 and the inner circumference 790. The plurality of circumferential gaps 722 are also diametrically aligned with each other. For example, the circumferential gap 722B is diametrically aligned with the circumferential gap 722E, and the circumferential gap 722C is diametrically aligned with the circumferential gap 722F, and so forth. The plurality of circumferential gaps 722 can mitigate the toroidal effect that can be present in the core 770.

The core 770 also includes a plurality of distributed gaps 718 which separates each ferrite layer of the core 770. The plurality of distributed gaps 718 separate each of the plurality of intermediate layers 716, the end cap 712A from the spacer layer 714A, and the end cap 712B from the spacer layer 714B. For example, the distributed gap 718A separates intermediate layer 716A from intermediate layer 716B. Each of the plurality of distributed gaps 718 separates the core 770 further into additional partitions or pieces. Additionally, each distributed gap of the plurality of distributed gaps 718 extends between two diametrically opposed points along the outer circumference 780. Therefore, a single distributed gap can separate two of the outer intermediate layers 78 and two of the inner intermediate layers 76 of the plurality of intermediate layers 716. In the examples shown in FIGS. 7-10, the core 770 includes twenty-one (21) distributed gaps.

Each of the distributed gaps 718 is an air gap, which is a non-magnetic space intentionally introduced to improve the thermal properties of the solenoidal inductor 200C. Preferably, each of the distributed gaps 718 includes ceramics with very low magnetic permeability such as aluminum nitride (AlN), aluminum oxide (Al₂O₃), or another similar compound. The plurality of distributed gaps 718 can facilitate in dispersing the heat generated by the core 770 and the plurality of solenoidal windings 755.

Similar to the solenoidal inductor 200A, the solenoidal inductor 200C can be used to provide a nested solenoidal inductor. For example, another solenoidal inductor can be coaxially nested in the hollow center of the solenoidal inductor 200C and within the inner circumference 790. The coaxially nested solenoidal inductor would similarly be used in the coaxial power converter cell 100 as a high voltage input inductor, and the solenoidal inductor 200C would similarly be used in the coaxial power converter cell 100 as a low voltage output inductor.

The plurality of circumferential gaps 722 can mitigate magnetic cross-coupling between the coaxially nested solenoidal inductor and the solenoidal inductor 200C. Additionally, other components may be inserted into the hollow center of the solenoidal inductor 200C, such as other conductors and possibly tubes or cables. The plurality of circumferential gaps 722 can mitigate magnetic cross coupling between the other conductors and the solenoidal inductor 200C, thereby mitigating further noise and loss generation.

The solenoidal inductor 200C can include terminal clamps 785A and 785B (FIG. 9) which can include aluminum plates for connection of the solenoidal inductor 200C to other components in a power converter, such as the coaxial power converter cell 100. In some embodiments, the solenoidal inductor 200C can include potting or encapsulant such as epoxy or resin that fills gaps between each turn of the plurality of solenoidal windings 755 and the core 770, providing a further thermal extraction interface between the plurality of solenoidal windings 755 and the core 770.

The solenoidal inductors of the embodiments described herein can provide superior thermal and energy handling capabilities compared to conventional solenoidal inductors, especially for use with coaxial power converters. For example, the solenoidal inductors of the embodiments can provide superior performance in filtering, energy storage, controlling energy flow, managing ripple, and managing thermals for power conversion processes, especially when used with coaxial power converter cells.

The features, structures, or characteristics described above may be combined in one or more embodiments in any suitable manner, and the features discussed in the various embodiments are interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

Terms such as “top,” “bottom,” “side,” “front,” “back,” “right,” “rear,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims. If a component is described as having “one or more” of the component, it is understood that the component can be referred to as “at least one” component.

The terms “first,” “second,” etc. are used only as labels, rather than a limitation for a number of the objects. It is understood that if multiple components are shown, the components may be referred to as a “first” component, a “second” component, and so forth, to the extent applicable.

The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. A solenoidal inductor, comprising:
a core, comprising:
an inner circumference and an outer circumference;
a first end cap and a second end cap;
a plurality of spacer layers between the first end cap and the second end cap; and
a plurality of intermediate layers comprising a plurality of outer intermediate layers and a plurality of inner intermediate layers, the plurality of intermediate layers positioned between the plurality of spacer layers; and
a solenoidal winding wound around the plurality of inner intermediate layers with a plurality of turns, wherein each turn is axially shifted with respect to an axis of symmetry.

2. The solenoidal inductor of claim 1, wherein the solenoidal winding is positioned between the plurality of outer intermediate layers and the plurality of inner intermediate layers.

3. The solenoidal inductor of claim 1, wherein a turn-to-turn spacing between each of the plurality of turns is equal and determined based at least in part on achieving periodic symmetry of the plurality of turns.

4. The solenoidal inductor of claim 1, wherein the core further comprises a plurality of circumferential gaps distributed circumferentially with respect to the inner circumference and the outer circumference, each circumferential gap of the plurality of circumferential gaps partitioning the core into separate pieces.

5. The solenoidal inductor of claim 4, wherein each circumferential gap of the plurality of circumferential gaps extends from the inner circumference to the outer circumference.

6. The solenoidal inductor of claim 1, wherein the core further comprises a hollow and cylindrical center.

7. The solenoidal inductor of claim 6, wherein the solenoidal inductor is a nested solenoidal inductor, the nested solenoidal inductor comprising a second solenoidal inductor positioned within the hollow and cylindrical center.

8. The solenoidal inductor of claim 7, wherein the second solenoidal inductor comprises a core comprising a similar structure to the core of the solenoidal inductor.

9. The solenoidal inductor of claim 8, wherein the second solenoidal inductor comprises a solenoidal winding wound around a plurality of inner intermediate layers of the core of the second solenoidal inductor with a plurality of turns, the plurality of turns of the solenoidal winding of the second solenoidal inductor being greater than the plurality of turns of the solenoidal winding of the solenoidal inductor.

10. The solenoidal inductor of claim 9, wherein terminations of the solenoidal winding of the solenoidal inductor extend outwardly from the core in a first direction.

11. The solenoidal inductor of claim 7, wherein:
the solenoidal inductor is connectable to a coaxial power converter as a low voltage inductor; and
the second solenoidal inductor is connectable to the coaxial power converter as a high voltage inductor.

12. The solenoidal inductor of claim 10, wherein terminations of the solenoidal winding of the second solenoidal inductor extend outwardly from the core of the second solenoidal inductor in opposite directions from each other, the opposite directions being perpendicular to the first direction.

13. The solenoidal inductor of claim 1, wherein the core further comprises a plurality of distributed gaps, each distributed gap of the plurality of distributed gaps extending between two diametrically opposed points along the outer circumference of the core.

14. The solenoidal inductor of claim 13, wherein each distributed gap of the plurality of distributed gaps is an air gap.

15. The solenoidal inductor of claim 14, wherein the air gap comprises ceramic.

16. A solenoidal inductor, comprising:
a core, comprising:
an inner circumference and an outer circumference;
a first end cap and a second end cap;
a plurality of spacer layers between the first end cap and the second end cap; and
a plurality of intermediate layers comprising a plurality of outer intermediate layers and a plurality of inner intermediate layers, the plurality of intermediate layers positioned between the plurality of spacer layers; and
a plurality of solenoidal windings wound around the plurality of inner intermediate layers,
wherein the core comprises a plurality of circumferential gaps distributed circumferentially with respect to the inner circumference and the outer circumference.

17. The solenoidal inductor of claim 16, wherein the core further comprises a plurality of circumferential gaps symmetrically arranged with respect to the inner circumference and the outer circumference.

18. The solenoidal inductor of claim 16, wherein two or more of the plurality of circumferential gaps are diametrically aligned with each other.

19. The solenoidal inductor of claim 16, wherein the core further comprises a plurality of distributed gaps, each distributed gap of the plurality of distributed gaps extending between two diametrically opposed points along the outer circumference of the core.

20. The solenoidal inductor of claim 16, wherein the plurality of solenoidal windings are positioned between the plurality of outer intermediate layers and the plurality of inner intermediate layers.
